(19) United States
(12) Patent Application Publication
(10) Pub. No.: US 2004/0085759 A1
(43) Pub. Date: May 6, 2004

(54) Dual function exterior light fixture

(76) Inventor: Kim Kempf, Florissant, MO (US)

Correspondence Address: STURM & FIX LLP, 206 SIXTH AVENUE, SUITE 1213, DES MOINES, IA, 50309-4076, US

(21) Appl. No.: 10/283,968

(22) Filed: Oct. 31, 2002

(51) Int. Cl. F21S 8/00

(52) U.S. Cl. 362/145

(57) ABSTRACT

A dual function exterior light fixture (10) for use with both a light bulb (100) and an electrical power cord (200) provided with a three pronged plug (201) wherein, the light fixture (10) includes an upper housing segment (20), a lower housing segment (40), and a mounting base (50) all associated with a hollow intermediate housing segment (30) provided with an interior receptacle (60) having a receptacle housing (61) the upper portion of which is provided with an electrical plug receptacle (63) adapted to receive the three pronged plug (201) of an electrical power cord (200) when the lower housing segment (40) is disengaged from the intermediate housing segment (30).

### CROSS REFERENCE TO RELATED APPLICATIONS

This invention was the subject matter of Document Disclosure Program Registration No. 511,801, filed in the United States Patent and Trademark Office on May 20, 2002.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of light fixtures in general and in particular to an external light fixture containing a hidden electrical plug receptacle.

2. Description of Related Art

As can be seen by reference to the following U.S. Pat. Nos. 2,675,444; 2,667,571; 2,863,038; and, 2,509,809, the prior art is replete with myriad and diverse combined light bulb and electrical receptacle combinations.

While all of the aforementioned prior art constructions are more than adequate for the basic purpose and function for which they have been specifically designed, they are uniformly deficient with respect to their failure to provide a simple, efficient, and practical external light fixture with a hidden electrical receptacle that is adapted to receive a three prong plug for powering electrical power tools such as mowers, trimmers and chain saws.

As most homeowners having yard maintenance concerns are all too well aware, gas powered lawn and garden tools generate a significant amount of noise and offensive fumes whereas electrical versions of those tools normally require the need for an unsightly external three prong receptacle to provide power to the electrical tool.

As a consequence of the foregoing situation, there has existed a longstanding need among homeowners for a new and improved external light fixture having a commonplace external appearance including a removable component that exposes a hidden three prong electrical outlet receptacle, and the provision of such a construction is a stated objective of the present invention.

### BRIEF SUMMARY OF THE INVENTION

Briefly stated, the dual function external light fixture that forms the basis of the present invention comprises in general an intermediate housing segment operatively yet releasably connected to both an upper housing signpost and a lower housing segment wherein the intermediate housing segment is further provided with a mounting base, as well as, an upwardly facing light socket and a downwardly facing electrical receptacle.

As will be explained in greater detail further on in the specification, the intermediate, upper, and lower housing segments cooperate with one another to give the external appearance of a carriage house style external lamp having a mounting base that is affixed to the external wall of a house.

In addition, the lower housing segment is threadedly engaged with the intermediate housing segment to normally conceal the electrical socket and is then removed during those times that the electrical receptacle needs to be accessed by a three pronged electric plug to provide power to an electrical lawn mower, chain saw, etc.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a partially exploded perspective view of the light fixture of this invention coupled to an electrical power cord;

FIG. 2 is an isolated front plan view of the upper, intermediate and lower housing segments of the light fixture;

FIG. 3 is an exploded perspective view of the interior components of the intermediate housing segment;

FIG. 4 is a front plan view of the external light fixture with the lower housing segment removed; and,

FIG. 5 is a perspective view of the interior components of the intermediate housing segment is their assembled mode.

### DETAILED DESCRIPTION OF THE INVENTION

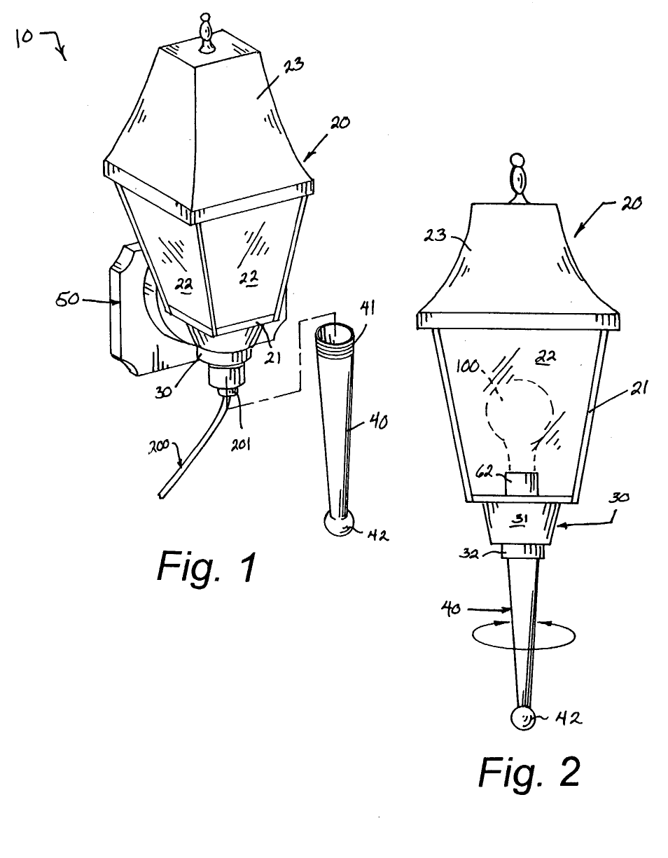

As can be seen by reference to the drawings, and in particularly to FIGS. 1 and 2, the dual function external light fixture that forms the basis of the present invention is designated generally by the reference number 10. The light fixture 10 comprises in general an upper housing segment 20, a hollow intermediate housing segment 30, and a lower housing segment 40 wherein, the intermediate housing segment 30 is further provided with a mounting base 50 and a dual function interior receptacle 60. These structural features will now be described in seriatim fashion.

As shown in FIGS. 1 and 2, the upper housing segment 20 includes a lower generally open framework element 21 that is adapted to support a plurality of outwardly angled transparent panels 22 fabricated from glass, clear plastic, etc., and an upper decorative cover element 23 that is adapted to be supported by and releasably connected to the lower framework element 21.

In addition, as depicted FIGS. 1,2,4 and 5, the intermediate housing segment 30 is provided with: an upper enlarged portion 31 fixedly or releasably connected to both the lower framework element 21 of the upper housing segment 20 and the mounting base 50 in a conventional manner, and a lower truncated hollow cylindrical portion 32 having internal threads (not shown) that releasably engage the threaded upper end 41 of the elongated tapered conical lower housing segment 40 the lower end of which is further provided with a decorative sphere element 42 such as a filagree or the like.

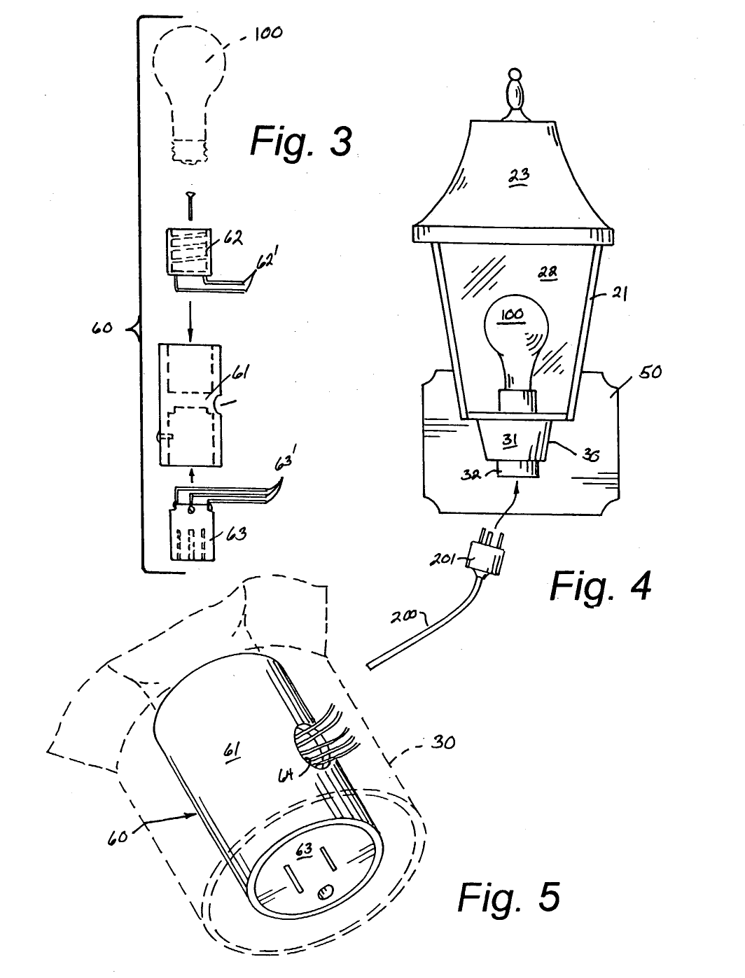

Turning now to FIG. 3, it can be seen that the crux of this invention involves the dual function receptacle 60 that is fixedly secured within the intermediate housing segment 30 and includes a receptacle housing 61 the upper end of which is provided with a wired light bulb socket 62 and the lower end of which is provided with a wired electrical plug receptacle 63 wherein, the light bulb socket 62 projects into the interior of the upper housing segment 20 to receive a conventional light bulb 100 and wherein the electrical plug receptacle 63 is adapted to receive the three pronged plug of a heavy duty electrical power cord 200 as depicted in FIGS. 1 and 4.

In addition, as depicted in FIGS. 3 and 5, one side of the receptacle housing 61 is provided with an opening 64 so that the electrical leads 62′ and 63′ from the light socket 62 and plug receptacle 63 can pass through the intermediate housing segment 30 and the mounting base 50 for connections to the internal house wiring (not shown) in a well recognized fashion.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A dual function external light fixture for use with a light bulb and an electrical power cord provided with a three pronged plug wherein, the light fixture comprises
a hollow intermediate housing segment having an enlarged upper portion and a reduced dimension lower portion
a mounting base fixedly connected to said intermediate housing segment
an upper housing segment including a lower framework element connected to the upper portion of the intermediate housing segment and an upper decorative cover element associated with the lower framework segment which is further provided with at least one transparent panel
a lower housing segment having an upper end releasably associated with the reduced dimension lower portion of the intermediate housing segment; and,
an interior receptacle disposed within the intermediate housing segment and including a receptacle housing having an upper end provided with a wired light bulb socket adapted to receive a light bulb and a lower end provided with a wired electrical plug receptacle adapted to receive the three pronged plug of an electrical power cord.

2. The light fixture as in claim 1; wherein, the lower framework element of the upper housing segment is releasably connected to the upper decorative cover element of the upper housing segment.

3. The light fixture as in claim 1; wherein, the lower framework element of the upper housing segment is releasably connected to the enlarged upper portion of the intermediate housing segment.

4. The light fixture as in claim 1; wherein, the lower framework element of the upper housing segment is fixedly connected to the enlarged upper portion of the intermediate housing segment.

5. The light fixture as in claim 1; wherein, the lower housing segment is threadedly engaged with the intermediate housing segment.

6. The light fixture as in claim 2; wherein, the lower housing segment is threadedly engaged with the intermediate housing segment.

7. The light fixture as in claim 3; wherein, the lower housing segment is threadedly engaged with the intermediate housing segment.

8. The light fixture as in claim 4; wherein, the lower housing segment is threadedly engaged with the intermediate housing segment.
